(19) United States
(12) Patent Application Publication
(10) Pub. No.: US 2025/0270122 A1
(43) Pub. Date: Aug. 28, 2025

(54) AQUATIC DYE AND COAGULANT COMBINATION PRODUCT TO IMPROVE THE LONGEVITY OF WATER QUALITY ENHANCEMENTS

(71) Applicant: SePRO Corporation, Carmel, IN (US)

(72) Inventors: Byran C. FUHRMANN, Rocky Mount, NC (US); West M. BISHOP, Kings Mountain, NC (US); Tim BITZ, McCordsville, IN (US)

(21) Appl. No.: 19/055,470

(22) Filed: Feb. 17, 2025

Related U.S. Application Data
(60) Provisional application No. 63/556,604, filed on Feb. 22, 2024.

(51) Int. Cl. C02F 1/56; C02F 1/52; C02F 1/54; C02F 103/00

(52) U.S. Cl. CPC C02F 1/56; C02F 1/5245; C02F 1/54; C02F 2103/007; C02F 2209/11

(57) ABSTRACT

A combination of aquatic dyes and trivalent cation-based coagulants that provide enhanced and prolonged in improvement in water quality when applied to surface water such as ponds, lakes, and reservoirs. In one embodiment, a coagulant-dye combination includes food-grade, water-soluble aquatic dyes and trivalent cation-based coagulants that are dissolved in a slightly acidic to acidic liquid solution. In another embodiment, a coagulant-dye combination is a homogeneous blend of water-soluble solids and may be contained in a water soluble packet or within a polymer to allow for the slow release of the ingredients.

### CROSS-REFERENCE TO RELATED APPLICATIONS

This application is related to and claims the benefit of U.S. Provisional Patent App. No. 63/556,604, filed Feb. 22, 2024, entitled AQUATIC DYE AND COAGULANT COMBINATION PRODUCT TO IMPROVE THE LONGEVITY OF WATER QUALITY ENHANCEMENTS, the entirety of which is incorporated herein by reference.

### GOVERNMENT RIGHTS STATEMENT

N/A.

### TECHNICAL FIELD

This disclosure relates to the use of a combination of an aquatic dye and a coagulant for extended improvement of water quality in surface waters such as lakes, reservoirs, and ponds.

### BACKGROUND

Coagulants that are comprised of trivalent cations such as aluminum, iron, lanthanum, and/or cerium are commonly used in water bodies to clarify the water column of debris, algae, and/or nutrients such as phosphorus. The water quality improvements following the use of these coagulants can vary dramatically depending on a variety of water body characteristics. The water quality improvement longevity can be limited, even in water bodies where there is no new input of nutrients, algae, or debris. Therefore, a method to improve the longevity of water quality improvements following the use of trivalent cation coagulants could be a valuable tool for both pond owners and large water body managers to reduce the labor and chemical demand for water resource management.

### SUMMARY

Some embodiments advantageously provide extended and enhanced control of water quality when simultaneously applied to a body of water where nutrients and excessive algae growth are present. In one embodiment, a combination aquatic dye and coagulant formulation includes: a first amount of an aquatic dye; and a second amount of a trivalent cation-based coagulant.

In one aspect of the embodiment, the coagulant-dye combination product has a pH below neutral.

In one aspect of the embodiment, the aquatic dye is a water-soluble salt and the trivalent cation-based coagulant is a water-soluble salt.

In one aspect of the embodiment, the coagulant-dye combination product is a solid blend of water-soluble salts.

In one aspect of the embodiment, the coagulant-dye combination product is a solid blend of water-soluble salts encapsulated within a water-soluble packet.

In one aspect of the embodiment, the coagulant-dye combination product is a solid blend of water-soluble salts contained inside a polymer that delays the release of the coagulant-dye combination product.

In one aspect of the embodiment, the aquatic dye includes at least one food-grade aquatic dye.

In one aspect of the embodiment, the aquatic dye includes at least one food-grade blue dye, at least one food-grade yellow dye, and/or at least one food-grade red dye.

In one aspect of the embodiment, the trivalent cation-based coagulant is water soluble and includes at least one aluminum salt, at least one aluminum polymer, at least one iron salt, at least one iron polymer, and/or at least one lanthanide salt.

In one aspect of the embodiment, the trivalent cation-based coagulant includes at least one aluminum salt, the at least one aluminum salt including aluminum sulfate and/or aluminum chloride.

In one aspect of the embodiment, the trivalent cation-based coagulant includes at least one aluminum polymer, the at least one aluminum polymer including polyaluminum chloride (PAC) and/or aluminum chlorohydrate (ACH).

In one aspect of the embodiment, the trivalent cation-based coagulant includes at least one iron salt, the at least one iron salt including ferric sulfate and/or ferric chloride.

In one aspect of the embodiment, the trivalent cation-based coagulant includes at least one iron polymer, the at least one iron polymer including ferric hydroxysulfate.

In one aspect of the embodiment, the trivalent cation-based coagulant includes at least one lanthanide salt, the at least one lanthanide salt including lanthanum chloride and/or cerium chloride.

In one aspect of the embodiment, the first amount of the aquatic dye is approximately 2.5% of the coagulant-dye combination product and the second amount of the trivalent cation-based coagulant is approximately 97.5% of the coagulant-dye combination product.

In one embodiment, a method of reducing turbidity in a body of water includes: combining a first amount of at least one aquatic dye and a second amount of at least one trivalent cation-based coagulant to create a coagulant-dye combination product; and applying the coagulant-dye combination product to a body of water.

In one aspect of the embodiment, the method further includes, before applying the coagulant-dye combination product to the body of water: mixing the coagulant-dye combination product with a third volume of water to create an aqueous coagulant-dye combination product, the third volume of water having an acidic pH; and applying the aqueous coagulant-dye combination product to the body of water as the coagulant-dye combination product.

In one aspect of the embodiment, the method further includes, before applying the coagulant-dye combination product to the body of water: encapsulating the coagulant-dye combination product in a water-soluble packet to create an encapsulated coagulant-dye combination product; and applying the encapsulated coagulant-dye combination product to the body of water as the coagulant-dye combination product.

In one aspect of the embodiment, the method further includes, before applying the coagulant-dye combination product to the body of water: packaging the coagulant-dye combination product within a polymer to form a slow-release coagulant-dye combination product, the polymer delaying release of the of the coagulant-dye combination product into the body of water; and applying the slow-release coagulant-dye combination product to the body of water as the coagulant-dye combination product.

In one aspect of the embodiment, the coagulant-dye combination product is applied in an amount sufficient to provide an application rate of the aquatic dye of approximately 290 μg/L and an application rate of the coagulant of approximately 5 mg/L.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows a first exemplary method of use, in accordance with the present disclosure;

FIG. 2 shows a second exemplary method of use, in accordance with the present disclosure;

FIG. 3 shows a third exemplary method of use, in accordance with the present disclosure; and

FIG. 4 is a chart showing a comparison of the percent reduction in surface water turbidity compared to the average of the three untreated controls for an aquatic dye by itself, a coagulant by itself, the expected reduction for a combination of the aquatic dye and coagulant, and the actual observed reduction for the combination of the aquatic dye and coagulant (the coagulant-dye combination product).

### DETAILED DESCRIPTION

Before describing in detail exemplary embodiments, it is noted that the embodiments reside primarily in combinations of apparatus components and steps related to methods and formulations of a liquid controlled-release pesticide for targeted delivery and drift reduction. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

This disclosure relates to the use of a combination of an aquatic dye and a coagulant for extended improvement of water quality in surface waters such as lakes, reservoirs, and ponds. In some embodiments, a combined aquatic dye and trivalent cation-based coagulant (referred to herein as a “coagulant-dye combination product” for simplicity) generally includes a food-grade dye composed of blue, yellow, and/or red pigments and trivalent-based coagulants composed of aluminum, iron, lanthanum, and/or cerium salts and/or polymers. In some embodiments, the dye(s) and coagulant(s) can be combined into a liquid with a pH below neutral (that is, a pH below 7). In other embodiments, the dye(s) and coagulant(s) can be combined as solids and/or contained in water-soluble packets to reduce the weight and/or volume required for the treatment of a known volume of water.

In one embodiment, a coagulant-dye combination product as disclosed herein displays extended and enhanced control of surface water turbidity, a marker of water quality, when compared with a dye or coagulant which are applied alone. That is, the coagulant-dye combination product is formulated to produce more effective control of surface water turbidity than only a dye applied alone and/or only a coagulant applied alone. In one non-limiting example, the coagulant-dye combination product functions as expected based on individual components in reducing surface water turbidity during the first 14 days after application and substantially reduces the surface water turbidity compared to application of each of its individual components alone and the expected water quality improvement based on the assumption of additive benefits at 42 days after application, demonstrating novel synergy of the combination.

In some embodiments, the coagulant-dye combination product includes a first amount of at least one aquatic dye and a second amount of at least one trivalent cation-based coagulant. In one embodiment, the at least one aquatic dye is water soluble and is or includes at least one food-grade aquatic dye. In one embodiment, the at least one aquatic dye is or includes acid blue 9, acid yellow 23, and/or red 40. The at least one trivalent cation-based coagulant is water soluble and is or includes an aluminum salt (including, but not limited to, aluminum sulfate and/or aluminum chloride), an aluminum polymer (including, but not limited to, polyaluminum chloride (PAC) and/or aluminum chlorohydrate (ACH)), an iron salt (including, but not limited to, ferric sulfate and/or ferric chloride), an iron polymer (including, but not limited to, ferric hydroxysulfate), a lanthanide salt (including, but not limited to, lanthanum chloride and/or cerium chloride), and/or combinations thereof. As is discussed in greater detail below, the coagulant-dye combination product is more effective in improving water quality in surface waters than either the aquatic dye or the coagulant alone. Therefore, the aquatic dye(s) and coagulant(s) act synergistically (have a synergistic effect). Thus, in some embodiments, it can be said that the coagulant-dye combination product includes a first amount of at least one aquatic dye and a synergistically effective second amount of at least one trivalent cation-based coagulant.

In some embodiments, the aquatic dye(s) and trivalent cation-based coagulant(s) are mixed in a solution of water with a pH below neutral (slightly acidic to acidic) to create a concentrated liquid coagulant-dye combination product. The concentrated liquid coagulant-dye combination product may be further mixed with water before use in a body of water, or may be used by directly applying, without dilution, to a body of water as an aqueous coagulant-dye combination product. In some embodiments, the solids, salts, and/or salt hydrates of each of the aquatic dye(s) and trivalent cation-based coagulant(s) can be mixed to create a concentrated solid mixture that can be diluted/dissolved in water or the concentrated solid mixture can be added directly to a body of water. In another embodiment, the solids of each of the aquatic dye(s) and trivalent cation-based coagulant(s) are mixed (either in dry or liquid form) and then encapsulated in a water-soluble packet that dissolves after being added to a body of water or are mixed and then contained or packaged within a polymer that allows for the slow-release of the coagulant-dye combination product when added to a body of water. Thus, in some embodiments, the coagulant-dye combination product is sold in a ready-to-use form as an aqueous coagulant-dye combination product, a concentrated solid coagulant-dye combination product, an encapsulated coagulant-dye combination product, and/or the coagulant-dye combination product packaged in a polymer, and the user merely applies the product to a body of water without further dilution, mixing, or preparation. In some embodiments, the coagulant-dye combination product is sold as a concentrated solid coagulant-dye combination product that the user dilutes, mixes, and/or prepares before applying to a body of water.

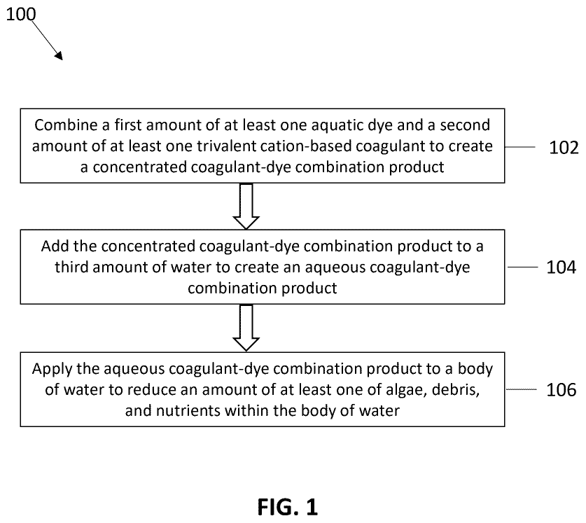

Referring now to FIG. 1, a first exemplary method of use 100 is shown. In a first step 102 of the first exemplary method of use 100, a first amount of at least one aquatic dye and a second amount of at least one trivalent cation-based coagulant are combined to create a concentrated coagulant-dye combination product. In a second step 104 of the first exemplary method of use 100, the concentrated coagulant-dye combination product is then added to a third amount of water (or the third amount of water is added to the concentrated coagulant-dye combination product) to create an aqueous coagulant-dye combination product. In one embodiment, the third amount of water has a pH that is below neutral. In this second step 104 of the first exemplary method of use 100, the aqueous coagulant-dye combination product may also be referred to as a diluted coagulant-dye combination product. The coagulant-dye combination product may be referred to as a concentrated coagulant-dye combination product (Step 102) before being mixed with the third amount of water to form the aqueous coagulant-dye concentration product (Step 104). In one embodiment, each of the at least one aquatic dye and the at least one coagulant in the concentrated coagulant-dye combination product is in the form of a water-soluble salt. In one embodiment, the concentrated coagulant-dye combination product is in the form of a solid blend of water-soluble salts. In one embodiment, the first amount of at least one aquatic dye is approximately 5% (±3%) of the concentrated coagulant-dye combination product and the second amount of coagulant is approximately 95% (±3%) of the coagulant-dye combination product. In one embodiment, the first amount of at least one aquatic dye is approximately 1.5% (±0.5%) of the concentrated coagulant-dye combination product and the second amount of coagulant is approximately 98.5% (±0.5%) of the concentrated coagulant-dye combination product. In one embodiment, the aquatic dye is present in the diluted coagulant-dye combination product in an amount of approximately 290 μg/L (±2 μg/L) and the coagulant is present in the diluted coagulant-dye combination product in an amount sufficient to provide approximately 5 mg/L (±0.5 mg/L) of elemental aluminum, iron, cerium, and/or lanthanum when added to a body of water.

Continuing to refer to FIG. 1, in a third step 106 of the first exemplary method of use 100, the aqueous coagulant-dye combination product is applied to a body of water to reduce turbidity, or an amount of algae, debris, and/or nutrients (for example, phosphorus) from the body of water. Put another way, applying the aqueous coagulant-dye combination product to a body of water causes a reduction in turbidity in the body of water. This may be referred to as a “clearing effect.” In one embodiment, the body of water has a known volume, and the composition of the coagulant-dye combination product is formulated to have a target clearing effect on the known volume when applied as the diluted coagulant-dye combination product. In some embodiments, the first exemplary method of use 100 optionally includes an additional step before the third step 106, in which a user calculates the volume of the body of water and then calculates the amount of coagulant-dye combination product that is needed to produce a target clearing effect. In one embodiment, the coagulant-dye combination product is sold as a concentrated coagulant-dye combination product and then mixed with water to form the aqueous (diluted) coagulant-dye combination product before application to the body of water. In one embodiment, the diluted coagulant-dye combination product is sprayed onto or poured into the body of water.

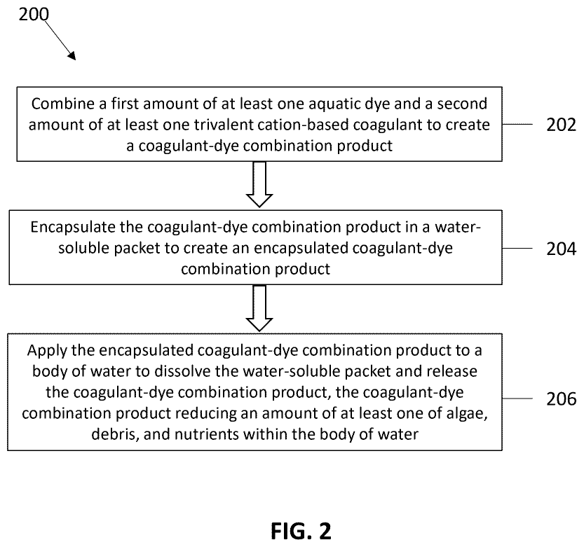

Referring now to FIG. 2, a second exemplary method of use 200 is shown. In a first step 202 of the second exemplary method of use 200, a first amount of at least one aquatic dye and a second amount of at least one trivalent cation-based coagulant are combined to create a coagulant-dye combination product. In a second step 204 of the second exemplary method of use 200, the coagulant-dye combination product is then encapsulated in a water-soluble packet to create an encapsulated coagulant-dye combination product. In one embodiment, the water-soluble packet is composed of a material that is sufficient to keep the ingredients encapsulated in ambient humidity, but that readily dissolves when submerged in or placed in contact with water. In one embodiment, the water-soluble packet is composed of a polymer including, but not limited to, polyvinyl alcohol. In one embodiment, each of the at least one aquatic dye and the at least one coagulant is in the form of a water-soluble salt. In one embodiment, the coagulant-dye combination product is in the form of a solid blend of water-soluble salts. In one embodiment, the first amount of at least one aquatic dye is approximately 5% (±3%) of the encapsulated coagulant-dye combination product and the second amount of coagulant is approximately 95% (±3%) of the encapsulated coagulant-dye combination product. In one embodiment, the first amount of at least one aquatic dye is approximately 1.5% (±0.5%) of the encapsulated coagulant-dye combination product and the second amount of coagulant is approximately 98.5% (±0.5%) of the encapsulated coagulant-dye combination product. In one embodiment, the aquatic dye is present in the encapsulated coagulant-dye combination product in an amount of approximately 290 μg/L (±2 μg/L) and the coagulant is present in the encapsulated coagulant-dye combination product in an amount sufficient to provide approximately 5 mg/L (±0.5 mg/L) of elemental aluminum, iron, cerium, and/or lanthanum when the encapsulated coagulant-dye combination product is added to a body of water.

Continuing to refer to FIG. 2, in a third step 206 of the second exemplary method of use 200, the encapsulated coagulant-dye combination product is applied to a body of water to reduce turbidity, or an amount of algae, debris, and/or nutrients (for example, phosphorus) from the body of water. Put another way, applying the encapsulated coagulant-dye combination product to a body of water causes a reduction in turbidity in the body of water. In one embodiment, the body of water has a known volume, and the composition of the encapsulated coagulant-dye combination product is formulated to have a target clearing effect on the known volume. In some embodiments, the second exemplary method of use 200 optionally includes an additional step before the third step 206, in which a user calculates the volume of the body of water and then calculates the amount of coagulant-dye combination product that is needed to produce a target clearing effect. In one embodiment, the coagulant-dye combination product is sold as an encapsulated coagulant-dye combination product, and mixing with water is not required before application to the body of water. In one embodiment, the encapsulated coagulant-dye combination product is dropped, thrown, or placed into the body of water.

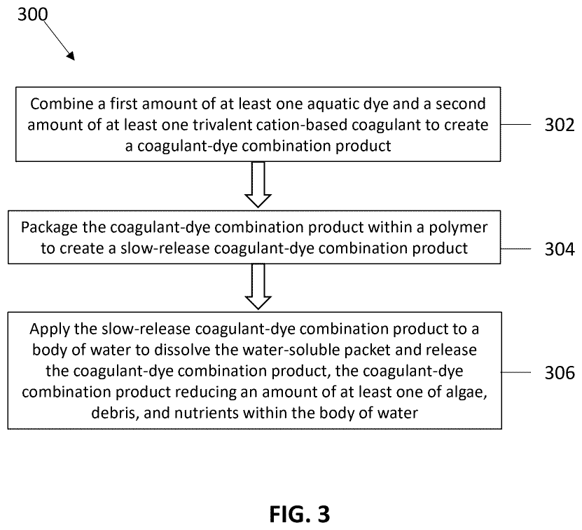

Referring now to FIG. 3, a third exemplary method of use 300 is shown. In a first step 302 of the third exemplary method of use 300, a first amount of at least one aquatic dye and a second amount of at least one trivalent cation-based coagulant are combined to create a coagulant-dye combination product. In a second step 302 of the second exemplary method of use 300, the coagulant-dye combination product is then packaged within a polymer to create slow-release coagulant-dye combination product. In one embodiment, the polymer includes polyacrylamide. In one embodiment, the slow-release coagulant-dye combined product is prepared by adding a first amount of dye to an acidic liquid trivalent metal solution (coagulant) and then adding polyacrylamide while stirring until a gel forms. In one embodiment, the slow-release coagulant-dye combination product is formulated to release 50% of the coagulant-dye combined product within 12 hours. In one embodiment, each of the at least one aquatic dye and the at least one coagulant is in the form of a water-soluble salt. In one embodiment, the coagulant-dye combination product is in the form of a solid blend of water-soluble salts. In one embodiment, the first amount of at least one aquatic dye is approximately 5% (±3%) of the slow-release coagulant-dye combination product and the second amount of coagulant is approximately 95% (±3%) of the slow-release coagulant-dye combination product. In one embodiment, the first amount of at least one aquatic dye is approximately 1.5% (±0.5%) of the slow-release coagulant-dye combination product and the second amount of coagulant is approximately 98.5% (±0.5%) of the slow-release coagulant-dye combination product. In one embodiment, the aquatic dye is present in the slow-release coagulant-dye combination product in an amount of approximately 290 μg/L (±2 μg/L) and the coagulant is present in the slow-release coagulant-dye combination product in an amount sufficient to provide approximately 5 mg/L (0.5 mg/L) of elemental aluminum, iron, cerium, and/or lanthanum when added to a body of water.

Continuing to refer to FIG. 3, in a third step of the second exemplary method of use, the coagulant-dye combination product is applied to a body of water to reduce turbidity, or an amount of algae, debris, and/or nutrients (for example, phosphorus) from the body of water through a slow-release of the components of the coagulant-dye combination product. Put another way, applying the aqueous coagulant-dye combination product to a body of water causes a reduction in turbidity in the body of water. In one embodiment, the body of water has a known volume, and the composition of the slow-release coagulant-dye combination product is formulated to have a target clearing effect on the known volume, and within a target amount of time. In some embodiments, the third exemplary method of use 300 optionally includes an additional step before the third step 306, in which a user calculates the volume of the body of water and then calculates the amount of coagulant-dye combination product that is needed to produce a target clearing effect. In one embodiment, the coagulant-dye combination product is sold as a slow-release coagulant-dye combination product wherein the coagulant-dye combination product is contained within single-dose polymer packets, and mixing with water is not required before application to the body of water. In one embodiment, the slow-release coagulant-dye combination product is dropped, thrown, or placed into the body of water.

Non-limiting examples of controlled-release liquid aquatic pesticide formulations are discussed in Example 1 below.

### Example 1

In a first, non-limiting example (Example 1), the coagulant-dye combination product is a mixture of a liquid aquatic dye (Aquashade® Plus, SePRO Corporation, Indiana, United States) and a liquid coagulant (Delpac® XG, USALCO, LLC, Maryland, United States). The liquid aquatic dye contains two aquatic dye components: 30.45% acid blue 9 (erioglaucine) by weight and 2.45% acid yellow 23 (tartrazine) by weight. The liquid coagulant contains 12.5% aluminum by weight as aluminum chlorohydrate (ACH). The coagulant-dye combination product in this Example 1 is 97.5% liquid coagulant and 2.5% aquatic dye, by volume. The pH of each component and the final combination is approximately 3.2-3.4.

In a first experiment in this Example 1, four acrylic cylinders (each having a diameter of 12 cm and a height of 60 cm, each containing approximately 6.75 liters when full) were placed in a greenhouse at a temperature of approximately 86° F. Each of the four cylinders was filled with a homogenized blend of algae and nutrient-rich pond water to approximately 1 cm below the top of the cylinder. The turbidity of the surface water in each cylinder was measured using a Sper Scientific® (Sper Scientific Instruments LLC, Arizona, United States) turbidity meter that meets IXO 7027 standards (model 860040) to confirm that all cylinders contained water with the same surface water turbidity. These cylinders were contained under an irrigation system that sprayed local well water twice per day, in order to prevent evaporation from reducing the total water volume. One of the cylinders was left as untreated controls and the other three cylinders were treated with either the liquid aquatic dye, the liquid coagulant, or a coagulant-dye combination product. For the aquatic-dye-only treatment, the concentrated liquid aquatic dye was diluted 1:100 and 520 μL of this solution was added to the first cylinder, at a rate of 0.25 gallons of concentrated liquid per acre-ft or 325,851 gallons, dosing the water within the cylinder to a concentration of 268 μg/L acid blue 9 and 22 μg/L of acid yellow 23. For the liquid-coagulant-only treatment, 202 μL of the concentrated liquid coagulant was added to the second cylinder, at a rate of 9.73 gallons per acre-ft or 325,851 gallons, dosing the water within the cylinder to a concentration of 5 mg/L of elemental aluminum. For the coagulant-dye-combination-product treatment, 207 μL of the concentrated coagulant-dye combination product liquid, containing 2.5% dye and 97.5% coagulant, was directly added to the third cylinder at a rate which dosed the water to the same dye concentration (268 μg/L acid blue 9 and 22 μg/L of acid yellow 23) and coagulant concentration (5 mg/L of elemental aluminum). No treatment was applied to the fourth (control) cylinder. Turbidity samples were taken 7, 14, 28, and 42 days after treatment at approximately 5 cm below the surface of the water within each cylinder using a syringe and measured using the same turbidity meter that was used to confirm all cylinders contained water with the same turbidity at the start of the experiment.

A comparison of turbidity measurements for each cylinder, including the average of the three controls, is listed below in Table 1:

TABLE 1
Turbidity of untreated controls and treatments in Experiment 1.

| | Turbidity (NTUs) | | | | |
|---|---|---|---|---|---|
| | | 7 days | 14 days | 28 days | 42 days |
| | Pre- | post- | post- | post- | post- |
| Sample | treatment | treatment | treatment | treatment | treatment |
| Untreated | 30.8 | 19.2 | 19.0 | 22.9 | 42.0 |
| control | | | | | |
| Dye only | 30.8 | 19.6 | 18.5 | 22.9 | 34.5 |
| Coagulant | 30.8 | 18.5 | 18.6 | 20.2 | 37.3 |
| only | | | | | |
| Coagulant- | 30.8 | 18.5 | 18.5 | 15.4 | 19.2 |
| dye | | | | | |
| combination | | | | | |

The results in Table 1 demonstrate that the control and all three treatments had a reduction in the surface water turbidity at day 7 and at day 14 compared to the original turbidity, likely due to the change in environmental conditions for the algae present within the water. At day 28, the turbidity increased in the control, the dye-only treatment (“dye only”), and coagulant-only treatment (“coagulant only”), but decreased in the coagulant-dye-combination-product treatment (“coagulant-dye combination”). At day 42, the turbidity increased substantially in the control, the dye-only treatment, and the coagulant-only; however, the turbidity increased only slightly in the coagulant-dye-combination-product treatment.

The data shown in Table 1 was used to calculate a percent reduction in surface water turbidity compared to the control, which was then used to compare an expected reduction in turbidity to an actual reduction in turbidity in samples treated with the coagulant-dye combination product. Those results are shown below in Table 2:

TABLE 2
Percent reduction in turbidity (individual treatments, expected
combination, and actual dye-coagulant combination product).

| | Turbidity Reduction Compared to the Control | | | | |
|---|---|---|---|---|---|
| | (Days after treatment) | | | | |
| Metric | 0 | 7 | 14 | 28 | 42 |
| Reduction from dye | 0% | 2% | 3% | 0% | 18% |
| treatment | | | | | |
| Reduction from | 0% | 4% | 2% | 12% | 11% |
| coagulant treatment | | | | | |
| Expected combination | 0% | 2% | 5% | 12% | 29% |
| reduction (dye | | | | | |
| treatment + coagulant | | | | | |
| treatment) | | | | | |
| Actual reduction from | 0% | 4% | 3% | 33% | 54% |
| dye-coagulant combined | | | | | |
| product treatment | | | | | |

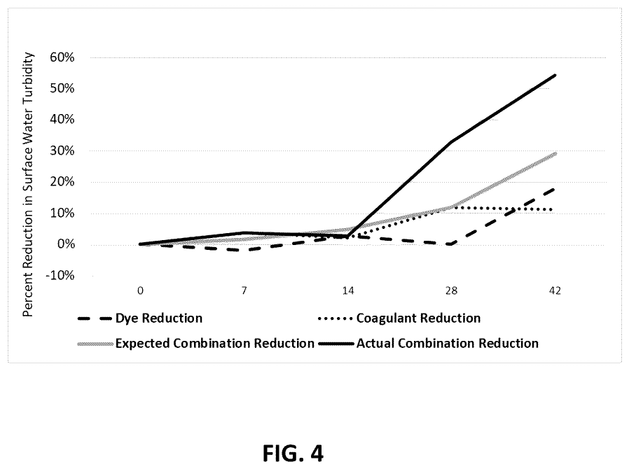

The percent reduction in surface water turbidity compared to the control was calculated for each treatment at each measurement point after treatment (0 days, 7 days, 14 days, 28 days, and 42 days) by subtracting the turbidity in each treatment from the turbidity in the control and diving that value by the turbidity in the control. The expected combination reduction in turbidity was calculated by adding the reduction of the dye only and the reduction of the coagulant only. The actual combination reduction in turbidity was the percent reduction in surface water turbidity compared to the control samples for the samples that received treatment with the coagulant-dye combination product (calculated by subtracting the turbidity in the samples that received treatment with the coagulant-dye-combination product from the turbidity in the control and dividing that value by the turbidity in the control). These results, which are shown in Table 2 and FIG. 4, demonstrate the synergistic reduction in surface water turbidity for the coagulant and aquatic dye combination for prolonged improvements in water quality. Put another way, treatment of a body of water with a coagulant-dye combination product produced a synergistic reduction in turbidity over time, which synergistic reduction effect is greater than a reduction in turbidity over time produced by a dye-only treatment and greater than a reduction in turbidity over time produced by a coagulant-only treatment. For example, Table 1 shows that, at 42 days post-treatment, the dye-only treatment displayed an increase in turbidity (34.5) and the coagulant-only treatment displayed an increase in turbidity (37.3). Therefore, it would be expected that a mixture of dye and coagulant would likewise display an increase in turbidity. However, the coagulant-dye-combination-product treatment surprisingly displayed a decrease in turbidity. This shows the combination of components produces a synergistic reduction in turbidity that is greater than a treatment consisting of either component alone. Indeed, Table 2 and FIG. 4 show that treatment with the coagulant-dye combination product produced a 33% reduction in turbidity where only a 12% reduction could have been expected (additive reduction of 0% from the dye plus 12% from the coagulant) at 28 days after treatment, and treatment with the coagulant-dye combination product produced a 54% reduction in turbidity where only a 29% reduction could have been expected (additive reduction of 18% from the dye plus 11% from the coagulant) at 42 days after treatment. Further, such results are expected until the dye in the coagulant dye combination product degrades (for example, as a result of exposure to UV light). In one embodiment, the dye in the coagulant dye combination product is expected to persist for approximately 3 months or more. In one embodiment, the dye in the coagulant dye combination product is expected to persist for approximately 3 months to approximately 6 months.

### Embodiments

In one embodiment, a combination aquatic dye and coagulant formulation includes: a first amount of an aquatic dye; and a second amount of a trivalent cation-based coagulant.

In one aspect of the embodiment, the coagulant-dye combination product has an acidic pH.

In one aspect of the embodiment, the aquatic dye is a water-soluble salt and the trivalent cation-based coagulant is a water-soluble salt.

In one aspect of the embodiment, the coagulant-dye combination product is a solid blend of water-soluble salts.

In one aspect of the embodiment, the coagulant-dye combination product is a solid blend of water-soluble salts encapsulated within a water-soluble packet.

In one aspect of the embodiment, the coagulant-dye combination product is a solid blend of water-soluble salts contained inside a polymer that delays the release of the coagulant-dye combination product.

In one aspect of the embodiment, the aquatic dye includes at least one food-grade aquatic dye.

In one aspect of the embodiment, the aquatic dye includes at least one food-grade blue dye, at least one food-grade yellow dye, and/or at least one food-grade red dye.

In one aspect of the embodiment, the trivalent cation-based coagulant is water soluble and is selected from a group consisting of: at least one aluminum salt, at least one aluminum polymer, at least one iron salt, at least one iron polymer, and at least one lanthanide salt.

In one aspect of the embodiment, the trivalent cation-based coagulant includes at least one aluminum salt, the at least one aluminum salt including aluminum sulfate and/or aluminum chloride.

In one aspect of the embodiment, the trivalent cation-based coagulant includes at least one aluminum polymer, the at least one aluminum polymer including polyaluminum chloride (PAC) and/or aluminum chlorohydrate (ACH).

In one aspect of the embodiment, the trivalent cation-based coagulant includes at least one iron salt, the at least one iron salt including ferric sulfate and/or ferric chloride.

In one aspect of the embodiment, the trivalent cation-based coagulant includes at least one iron polymer, the at least one iron polymer including ferric hydroxysulfate.

In one aspect of the embodiment, the trivalent cation-based coagulant includes at least one lanthanide salt, the at least one lanthanide salt including lanthanum chloride and/or cerium chloride.

In one aspect of the embodiment, the first amount of the aquatic dye is approximately 2.5% of the coagulant-dye combination product and the second amount of the trivalent cation-based coagulant is approximately 97.5% of the coagulant-dye combination product.

In one embodiment, a method of reducing turbidity in a body of water includes: combining a first amount of at least one aquatic dye and a second amount of at least one trivalent cation-based coagulant to create a coagulant-dye combination product; and applying the coagulant-dye combination product to a body of water.

In one aspect of the embodiment, the method further includes, before applying the coagulant-dye combination product to the body of water: mixing the coagulant-dye combination product with a third volume of water to create a diluted coagulant-dye combination product, the third volume of water having an acidic pH; and applying the diluted coagulant-dye combination product to the body of water as the coagulant-dye combination product.

In one embodiment, the method further includes, before applying the coagulant-dye combination product to the body of water: encapsulating the coagulant-dye combination product in a water-soluble packet to create an encapsulated coagulant-dye combination product; and applying the encapsulated coagulant-dye combination product to the body of water as the coagulant-dye combination product.

In one aspect of the embodiment, the method further includes, before applying the coagulant-dye combination product to the body of water: packaging the coagulant-dye combination product within a polymer to form a slow-release coagulant-dye combination product, the polymer delaying release of the of the coagulant-dye combination product into the body of water; and applying the slow-release coagulant-dye combination product to the body of water as the coagulant-dye combination product.

In one aspect of the embodiment, the coagulant-dye combination product is applied in an amount sufficient to provide an application rate of the aquatic dye of approximately 290 μg/L and an application rate of the coagulant of approximately 5 mg/L.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A coagulant-dye combination product, comprising:
a first amount of an aquatic dye; and
a second amount of a trivalent cation-based coagulant.

2. The coagulant-dye combination product of claim 1, wherein the coagulant-dye combination product has a pH below neutral.

3. The coagulant-dye combination product of claim 2, wherein the aquatic dye is a water-soluble salt and the trivalent cation-based coagulant is a water-soluble salt.

4. The coagulant-dye combination product of claim 1, wherein the coagulant-dye combination product is a solid blend of water-soluble salts.

5. The coagulant-dye combination product of claim 1, wherein the coagulant-dye combination product is a solid blend of water-soluble salts encapsulated within a water-soluble packet.

6. The coagulant-dye combination product of claim 1, wherein the coagulant-dye combination product is a solid blend of water-soluble salts contained inside a polymer that delays the release of the coagulant-dye combination product.

7. The coagulant-dye combination product of claim 1, wherein the aquatic dye includes at least one food-grade aquatic dye.

8. The coagulant-dye combination product of claim 1, wherein the aquatic dye includes at least one food-grade blue dye, at least one food-grade yellow dye, and/or at least one food-grade red dye.

9. The coagulant-dye combination product of claim 1, wherein the trivalent cation-based coagulant is water soluble and includes at least one aluminum salt, at least one aluminum polymer, at least one iron salt, at least one iron polymer, and/or at least one lanthanide salt.

10. The coagulant-dye combination product of claim 9, wherein the trivalent cation-based coagulant includes at least one aluminum salt, the at least one aluminum salt including aluminum sulfate and/or aluminum chloride.

11. The coagulant-dye combination product of claim 9, wherein the trivalent cation-based coagulant includes at least one aluminum polymer, the at least one aluminum polymer including polyaluminum chloride (PAC) and/or aluminum chlorohydrate (ACH).

12. The coagulant-dye combination product of claim 9, wherein the trivalent cation-based coagulant includes at least one iron salt, the at least one iron salt including ferric sulfate and/or ferric chloride.

13. The coagulant-dye combination product of claim 9, wherein the trivalent cation-based coagulant includes at least one iron polymer, the at least one iron polymer including ferric hydroxysulfate.

14. The coagulant-dye combination product of claim 9, wherein the trivalent cation-based coagulant includes at least one lanthanide salt, the at least one lanthanide salt including lanthanum chloride and/or cerium chloride.

15. The coagulant-dye combination product of claim 1, wherein the first amount of the aquatic dye is approximately 2.5% of the coagulant-dye combination product and the second amount of the trivalent cation-based coagulant is approximately 97.5% of the coagulant-dye combination product.

16. A method of reducing turbidity in a body of water, the method comprising:
combining a first amount of at least one aquatic dye and a second amount of at least one trivalent cation-based coagulant to create a coagulant-dye combination product; and
applying the coagulant-dye combination product to a body of water.

17. The method of claim 16, further comprising, before applying the coagulant-dye combination product to the body of water:
mixing the coagulant-dye combination product with a third volume of water to create an aqueous coagulant-dye combination product, the third volume of water having an acidic pH; and
applying the aqueous coagulant-dye combination product to the body of water as the coagulant-dye combination product.

18. The method of claim 16, further comprising, before applying the coagulant-dye combination product to the body of water:
encapsulating the coagulant-dye combination product in a water-soluble packet to create an encapsulated coagulant-dye combination product; and
applying the encapsulated coagulant-dye combination product to the body of water as the coagulant-dye combination product.

19. The method of claim 16, further comprising, before applying the coagulant-dye combination product to the body of water:
packaging the coagulant-dye combination product within a polymer to form a slow-release coagulant-dye combination product, the polymer delaying release of the of the coagulant-dye combination product into the body of water; and
applying the slow-release coagulant-dye combination product to the body of water as the coagulant-dye combination product.

20. The method of claim 16, wherein the coagulant-dye combination product is applied in an amount sufficient to provide an application rate of the aquatic dye of approximately 290 μg/L and an application rate of the coagulant of approximately 5 mg/L.
